(19) United States
(12) Patent Application Publication
(10) Pub. No.: US 2006/0256699 A1
(43) Pub. Date: Nov. 16, 2006

(54) Read equalizer for a data storage system

(75) Inventor: Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,182

(22) PCT Filed: Aug. 9, 2004
(86) PCT No.: PCT/IB04/51425

§ 371 Date: Feb. 22, 2006

(30) Foreign Application Priority Data
Aug. 27, 2003 (EP) 03103229.5

(51) Int. Cl. G11B 7/00

(52) U.S. Cl. 369/124.01

(57) ABSTRACT

A device for scanning a track on a record carrier for reading information has a head for generating a read signal. Marks in the track have a number of different shapes for representing the information. The device processes the read signal by a combination of a linear equalizer (81) and a non-linear equalizer (89). The linear equalizer (81) is arranged for equalizing based on a mark having a single predefined shape, and the non-linear equalizer (89) is arranged for reducing inter symbol interference in the read signal for marks having a different shape then said predefined shape. The inter symbol interference remaining in the read signal is effectively reduced by the non-linear equalizer (89) because it is optimized based on the fact that said linear equalizer (81) is optimized on said single predefined shape.

The invention relates to a device for scanning a track on a record carrier for reading information, the device comprising a head for generating a read signal via a beam of radiation for scanning marks in the track, the marks having a number of different shapes for representing the information.

The invention further relates to a method of equalizing a read signal during reading information in a track on a record carrier, the method comprising receiving a read signal generated by marks in the track, the marks having a number of different shapes for representing the information.

The record carrier may be of a recordable type and has a track for recording information, e.g. a spiral shaped track on a disc shaped carrier. For scanning the track an optical head is positioned at the track by a positioning unit. The head has a laser and optical elements for generating a beam of radiation for reading marks. The marks are physical patterns that represent the information and are optically detectable. A device and method for equalizing a read signal from such a record carrier are known from EP 0585095. A reproduction equalizer comprises a linear equalizer for linearly equalizing a source signal read from a recording medium, and a nonlinear cancellation means for canceling inter symbol interference (ISI) contained in the reproduction signal. The nonlinear cancellation means includes a lookup table storing the ISI data, a circuit for generating an address for reading out the ISI data from the lookup table, and a circuit for subtracting the read ISI data from the equalized source signal. The device has calculation means for automatically calculating and/or updating the ISI data held in the nonlinear cancellation means on the basis of the equalized source signal. At an initial stage, the calculation means calculates the ISI data, and in a normal operation mode, the calculated ISI data is used. A problem is that the known equalization system is not able to reduce inter symbol interference sufficiently in high density recording.

It is an object of the invention to provide a reading device and corresponding method for effectively repressing inter symbol interference.

For this purpose, the device as described in the opening paragraph has read means for processing the read signal the read means comprising a combination of a linear equalizer and a non-linear equalizer for equalizing the read signal, the linear equalizer being arranged for equalizing based on a mark having a single predefined shape, and the non-linear equalizer being arranged for reducing inter symbol interference in the read signal for marks having a different shape then said predefined shape, the inter symbol interference remaining in the read signal due to said linear equalizer being based on said single predefined shape.

The method as described in the opening paragraph comprises processing the read signal by a combination of linear equalization and a non-linear equalization for equalizing the read signal, the linear equalization being arranged for equalizing based on a mark having a single predefined shape, and the non-linear equalization being arranged for reducing inter symbol interference in the read signal for marks having a different shape than said predefined shape, the inter symbol interference remaining in the read signal due to said linear equalizer being based on said single predefined shape.

The effect of the measures is that the linear equalization is based on a predefined selection of one of the mark shapes to be distinguished, and the non-linear equalization is adapted to reduce the inter symbol interference for marks having different shapes based on the fact that the linear equalization is optimized for said first shape.

The invention is also based on the following recognition. In recent optical recording systems multi level codes are used. Multi level codes require read signals at different signal levels from a single mark, and the marks written on the recording medium are often thought of as different levels of grey. The grey levels correspond to the levels of the read signal. However, physically, grey cannot be written due to the nature of the recording medium, e.g. phase change material is either in a crystalline or amorphous state, magnetization is either up or down in magnetic system, etc. The inventors have seen that information in multilevel recording is contained in the shape of the marks rather than in the reflectivity. In particular, the information is contained in the length of marks resulting in different read signal levels. Because the length of the mark is varied for achieving the required signal level at a read-out time, the read signal at other relevant moments, i.e. at the read-out times of preceding and succeeding symbols, is also influenced, by so called inter symbol interference. Equalization is applied in the receiver to restore the required signal levels and reduce inter symbol interference. First the inventors have optimized the linear equalizer for a selected one of the expected read signal shapes. Secondly they have determined residual inter symbol interference based on a new descriptive channel model, which takes into account said optimized linear equalizer being used on a read signal that actually is generated by marks of different shapes. The non-linear equalizer is optimized based on the channel model knowing that the linear equalizer is optimized on a predefined one of a multitude of different mark shapes.

In an embodiment of the device the read means are for processing the read signal for generating a corresponding number of different levels of a processed read signal at a read-out time for said number of different shapes. The equalizer function is particularly suitable for restoring the read signal in a multilevel storage system. However, it is to be noted that the equalizer may also be used in a different read-out system, e.g. for optimizing zero crossings in a binary read-out signal.

In an embodiment of the device said number of different shapes comprises longer and shorter shapes, and the linear equalizer is arranged for equalizing based on a mark having a longer shape. The inventors have seen that when the linear equalizer is optimized for a longer shape, the residual inter symbol interference for the shorter shapes is less. This has the advantage that the inter symbol interference can be reduced further by the non-linear equalizer.

In an embodiment of the device the linear equalizer is arranged for equalizing based on a mark having the longest shape of said different shapes. In a practical embodiment the longest shape proved to be the choice having the least residual inter-symbol interference.

Further embodiments are given in the dependent claims.

These and other aspects of the invention will be apparent from and elucidated further with reference to the embodiments described by way of example in the following description and with reference to the accompanying drawings, in which

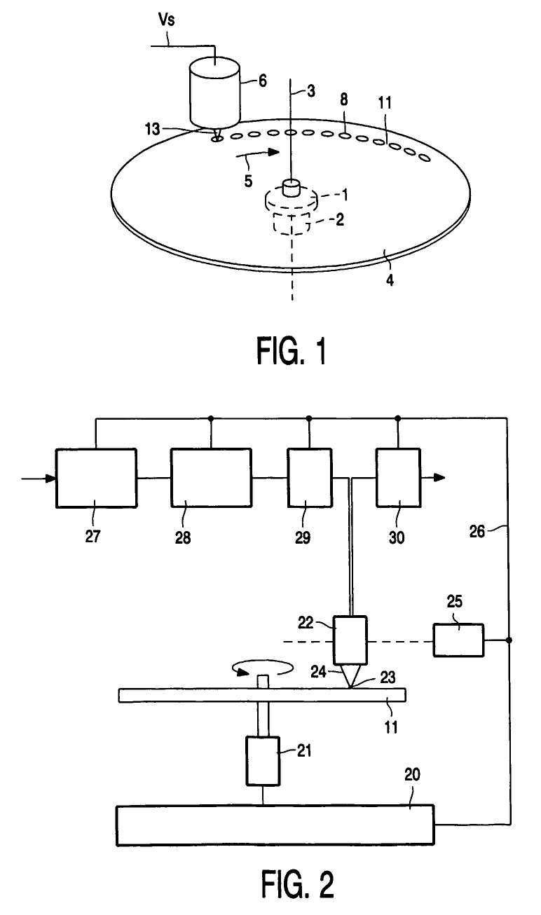

FIG. 1 shows diagrammatically an optical recording process,

FIG. 2 shows a scanning device,

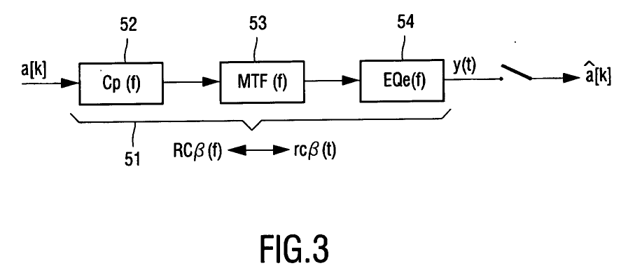

FIG. 3 shows a model for the channel of a multilevel storage system,

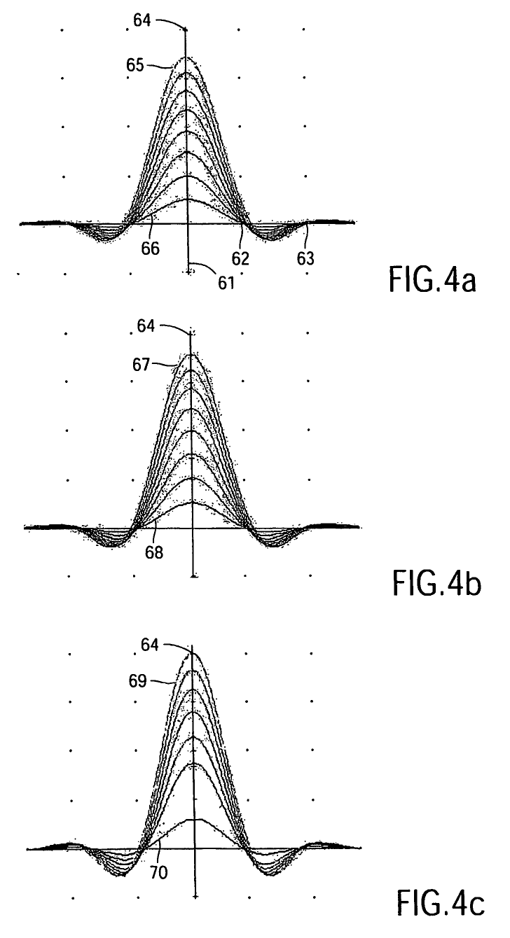

FIG. 4 shows pulses after equalization,

FIG. 4a shows pulses using an equalizer optimized for a minimum length pulse,

FIG. 4b shows pulses using an equalizer optimized for a medium length pulse,

FIG. 4c shows pulses using an equalizer optimized for a maximum length pulse,

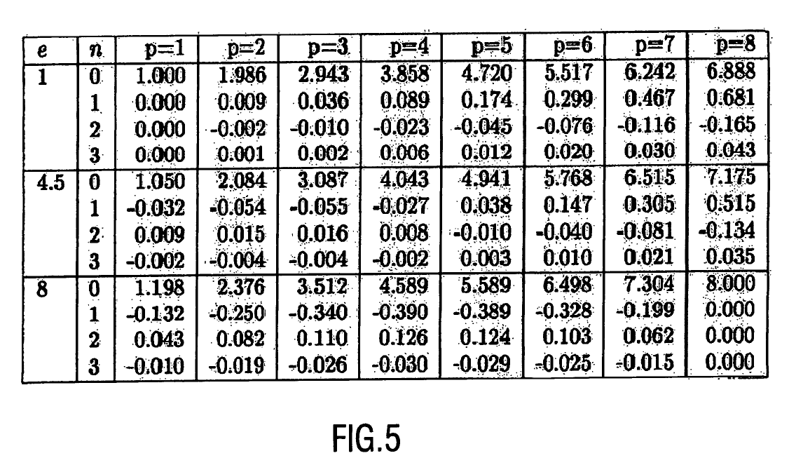

FIG. 5 shows inter symbol interference values dependent on the equalizer,

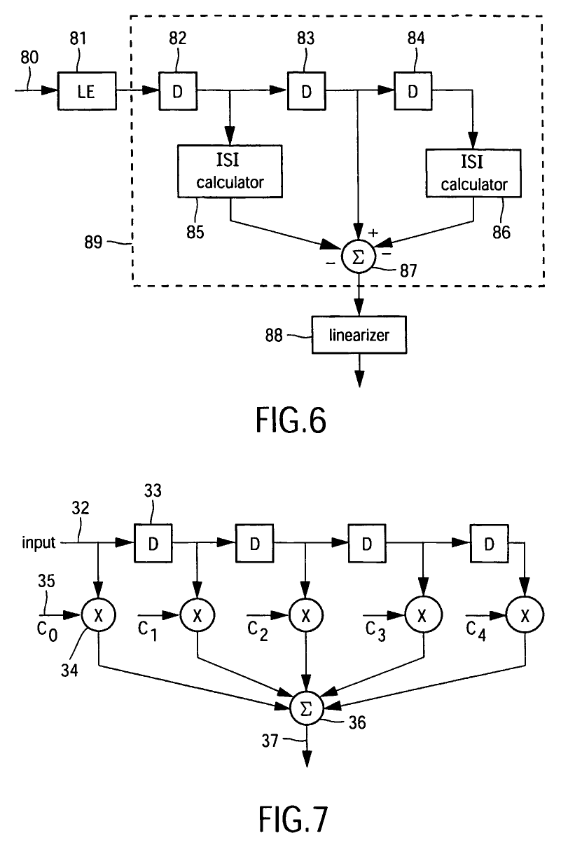

FIG. 6 shows read signal equalization,

FIG. 7 shows a linear equalizer,

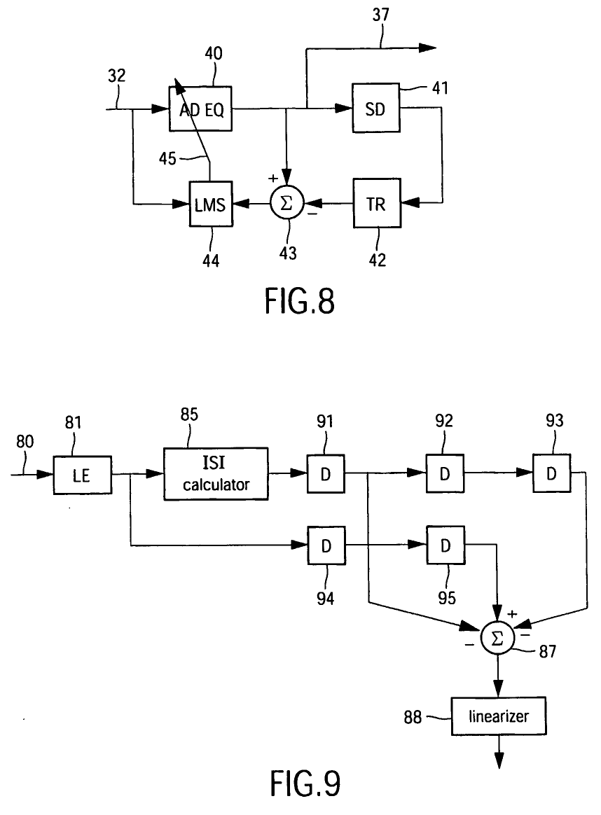

FIG. 8 shows a linear equalizer and adaptation of the coefficients,

FIG. 9 shows an alternative circuit for read signal equalization,

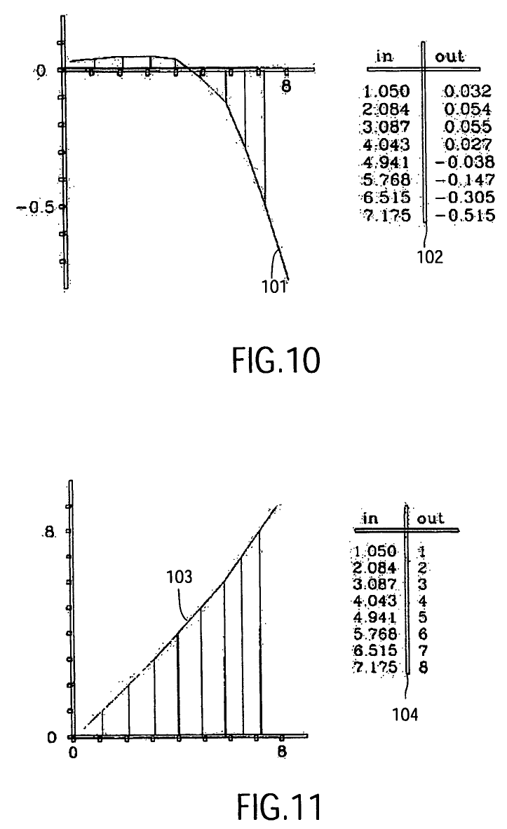

FIG. 10 shows correction values for an ISI calculator, and

FIG. 11 shows correction values for a linearizer.

Corresponding elements in different Figures have identical reference numerals.

FIG. 1 shows diagrammatically an optical recording process. Relevant elements of a recording device are shown comprising a turntable 1 and a drive motor 2 for rotating a disc shaped record carrier 4 about an axis 3 in a direction indicated by an arrow 5. The record carrier has a track 11 for recording marks 8, the track being located by a servo pattern for generating servo tracking signals for positioning an optical head opposite the track. The servo pattern may for example be a shallow wobbled groove, usually called a pre-groove, and/or a pattern of indentations, usually called pre-pits or servo pits. The record carrier 4 comprises a radiation-sensitive recording layer which upon exposure to radiation of sufficiently high intensity is subjected to an optically detectable change, such as for example a change in reflectivity, for forming marks 8 constituting a recorded pattern representing information. In the recorded pattern the marks have a specific shape, which represent the information. The representation may be according to a modulation scheme usually called channel code.

The radiation-sensitive layer may consist of material such as a radiation sensitive dye or a phase-change material, whose structure can be changed from amorphous to crystalline or vice versa under the influence of radiation. An optical write head 6 is arranged opposite the track of the (rotating) record carrier. The optical write head 6 comprises a radiation source, for example a solid-state laser, for generating a write beam 13. The intensity I of the write beam 13 is modulated in conformity with a control signal in a customary manner. The intensity of the write beam 13 varies between a write intensity, which is adequate to bring about detectable changes in the optical properties of the radiation-sensitive record carrier for forming marks and intermediate areas in between the marks further called space. In a write system a low (or zero) intensity, which does not bring about any detectable changes, may be used for creating spaces. High density rewriting systems using phase change material are usually based on a direct overwrite (DOW) writing. Therefore when a space is to be written, some write pulse is required to erase possible previous data on the disc. Usually, a melt pulse (high power) is given, followed by a lower level for a particular period to obtain (partial) regrowth of a crystalline area into the previously molten area. The marks may be in any optically readable form, e.g. in the form of areas with a reflection coefficient different from their surroundings, obtained when recording in materials such as dye, alloy or phase change material or in the form of areas with a direction of magnetization different from their surroundings, obtained when recording in magneto-optical material.

For reading the recording layer is scanned with a beam 13 whose intensity is at a reading level of a constant intensity which is low enough to preclude a detectable change in optical properties. During scanning the read beam reflected from the record carrier is modulated in conformity with the information pattern being scanned. The modulation of the read beam can be detected in a customary manner by means of a radiation-sensitive detector which generates a read signal which is indicative of the beam modulation.

FIG. 2 shows a scanning device for writing and/or reading information on a record carrier 11. The record carrier may be of a read-only type, e.g. manufactured by pressing like a CD or DVD-ROM, or the record carrier may be of a type which is writable or re-writable, for example a recordable DVD or BD (Blu-ray Disc). The device is provided with scanning means for scanning the track on the record carrier which means include a drive unit 21 for rotating the record carrier 11, a scanning unit 22 comprising an optical head and additional circuitry, a positioning unit 25 for coarsely positioning the optical head in the radial direction on the track, and a control unit 20. The optical head comprises an optical system of a known type for generating a radiation beam 24 guided through optical elements focused to a radiation spot 23 on a track of the information layer of the record carrier. The optical head and additional circuits constitute a scanning unit for generating signals detected from the radiation beam. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element.

It is noted that FIG. 2 shows a scanning device for writing and reading information. Alternatively a playback only device may contain only the reading elements described below. For writing information the radiation is controlled to create optically detectable marks in the recording layer. For reading the radiation reflected by the information layer is detected by a detector of a usual type, e.g. a four-quadrant diode, in the optical head for generating a read signal and further detector signals including a tracking error and a focusing error signal for controlling said tracking and focusing actuators. The read signal is processed by read processing unit 30 including an equalizer according to the invention, and a demodulator, deformatter and output unit of a usual type to retrieve the information. Hence elements for reading information include the drive unit 21, the optical head, the positioning unit 25 and the read processing unit 30. The device comprises write processing means for processing the input information to generate a write signal to drive the optical head, which means comprise an input unit 27, and a formatter 28 and a laser power unit 29. The control unit 20 controls the recording and retrieving of information and may be arranged for receiving commands from a user or from a host computer. The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates, for performing the writing and/or reading functions. The control unit 20 may also be implemented as a state machine in logic circuits.

The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates. The control unit 20 may also be implemented as a state machine in logic circuits.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording or playback apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to units of information, which are passed to the formatter 28. The read processing unit 30 may comprise suitable audio and/or video decoding units.

The formatter 28 is for adding control data and formatting and encoding the data according to the recording format, e.g. by adding error correction codes (ECC), interleaving and channel coding. Further the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed to the laser power unit 29.

The laser power unit 29 receives the formatted data indicating the marks to be written and generates a laser power control signal which drives the radiation source in the optical head. For multilevel recording different marks are used to generate different levels of the read-out signal during read-out at a specific read-out time. The track is subdivided in cells of a constant length, and each cell contains a mark representing one of a number of signal levels. Traditionally the marks are considered as grey. However, due to the nature of the physical phenomena used to form the marks, grey is not the physical constitution of the mark. Actually the read signal level of traditional multilevel systems is generated by different shapes of the marks, in particular the length. The laser power unit 29 is arranged for generating a power pattern for accurately writing marks of a preferred shape. The different lengths of a mark are not detected as such, but as different levels of the read signal value of a symbol in a cell, because the size of a radiation spot for detecting the contents of a cell is about the size of the cell itself. In other words, the size of the symbol (the cell) is selected as small as possible with respect to the detection system. In practice the radiation spot will also detect some of the contents of the neighboring cells, which causes inter symbol interference (ISI). Linear ISI can be compensated by linear equalization, provided that the Nyquist requirement is met. This requirement says that the symbol rate should be less than twice the bandwidth of the system. In our case, the symbol rate is f_{symbol} and the bandwidth is the optical cutoff being fc=2 NA/lambda, so we find that ISI can be fully eliminated (i.e. full response system) provided that f_{symbol}<4 NA/lambda). Non-linear ISI occurs in practical high-density systems.

For understanding the inter symbol interference a model for the channel of writing and reading of marks is discussed now. First, the residual ISI due to non-linear behavior of a pulse width (or duration) modulated (PWM) system is calculated. It is shown that the residual ISI is not negligible. The effects of ISI can be reduced by measures during writing (predistortion in the write channel, not discussed here), but also at read back, by equalization. The equalizer according to the invention is based on the following model.

FIG. 3 shows a model for the channel of a multilevel storage system. A channel 51 is provided with input symbols represented by a[k], which are converted to a discrete-time waveform by passing them through a pulse modulator 52. The pulse modulator 52 is described by a Fourier pair cₚ(t)⇄Cₚ(f). In case of amplitude modulation, there is only one pulse shape used, which is modulated in amplitude by the aₖ. In case of pulse width modulation, different pulses of different duration are used, dependent on the symbols aₖ to be transmitted. The pulse is given by the Fourier pair:

$${c}_{p} ( t ) = Π ( \frac{t}{D} ) ⟷ {C}_{p} ( f ) = \frac{sin ( π fD )}{π f}$$

The block function II used above is defined according to:

$$Π ( \frac{t}{D} ) = \{ \begin{matrix}1 & for - \frac{D}{2} \leq t \leq \frac{D}{2} \\ 0 & elsewhere\end{matrix}$$

In pulse width modulation, the duration D depends on the symbol to be transmitted, e.g. according to

$$D = \frac{p}{M} T ,$$

in which M is the alphabet size,

$$T = \frac{1}{{f}_{symbol}}$$

is the symbol time, and p is the pulse index. The optical channel is specified by its modulation transfer function (MTF):

$$MTF ( f ) = \{ \begin{matrix}\frac{2}{π} arccos ( \frac{\vert f \vert}{{f}_{c}} ) - \frac{2 \vert f \vert}{π {f}_{c}} \sqrt{1 - {( \frac{\vert f \vert}{{f}_{c}} )}^{2}} for \vert f \vert \leq {f}_{c} \\ 0 for \vert f \vert > {f}_{c}\end{matrix} \}$$

in which

$${f}_{c} = \frac{2 NA}{λ}$$

is the optical cut-off of the channel (NA being numerical aperture of the lens and λ being the wavelength). The equalizer EQ is chosen such as to obtain an ISI-free (known as full-response, or FR) system. From the model as shown in FIG. 3 it is clear that the FR equalizer is pulse modulator dependent as the total response has to satisfy RCβ(f). The index e is used to emphasize that the equalizer belongs to pulse e. As the pulse is not known in advance, it is not possible to use the corresponding equalizer in the receiver. Consequently, a pulse width modulation system cannot be FR. Instead, the system will be non-linear and show residual ISI. By proper compensation, non-linearity and ISI can be made small. Compensation may be applied via precompensation in the write channel. However, compensation may also be done in the read channel, which is advantageous when it is not possible to accurately control the write channel (read only discs like ROM and R, or written discs like RW after ageing). Initially assuming a linear system, the channel is made ISI-free by using a transfer function showing vestigial symmetry around half the symbol rate (according to Nyquist). In the sequel, the so-called raised cosine response, or RC response for short, a commonly function for this purpose, is given by:

$${RC}_{β} ( f ) = \{ \begin{matrix}\frac{1}{{f}_{symbol}} & for 0 \leq \vert f \vert \leq \frac{1 - β}{2} {f}_{symbol} \\ \frac{1}{2 {f}_{symbol}} \{ 1 - sin [ \frac{π}{β} ( \frac{f}{{f}_{ symbol}} - \frac{1}{2} ) ] \} & for \frac{1 - β}{2} {f}_{symbol} \leq \vert f \vert \leq \frac{1 + β}{2} {f}_{symbol} \\ 0 & for \vert f \vert \geq \frac{1 + β}{2} {f}_{symbol} . . .\end{matrix}$$

The parameter β determines the excess bandwidth (0≦β≦1, β=0 corresponding to no excess bandwidth, i.e. sinc response channel, and β=1 corresponding to 100% excess bandwidth). Now the cut-off of the RC-function is put at the MTF cut-off (one may do another choice but this would mean throwing away some of the HF part of the MTF). Consequently, β is not longer an independent parameter, but rather directly coupled to the density on disc. It is given by:

$$β = \frac{2 {f}_{c} - {f}_{symbol}}{{f}_{symbol}}$$

Because β is no longer an independent parameter, it is dropped from the notation in those cases where the above value is used. Substitution yields:

$$RC ( f ) = \{ \begin{matrix}\frac{1}{{f}_{symbol}} & for 0 \leq \vert f \vert \leq {f}_{symbol} - {f}_{c} \\ \frac{1}{2 {f}_{symbol}} \{ 1 - sin [ \frac{π {f}_{symbol}}{2 {f}_{c} - {f}_{symbol}} ( \frac{f}{{f}_{ symbol}} - \frac{1}{2} ) ] \} & for {f}_{symbol} - {f}_{c} \leq \vert f \vert \leq {f}_{c} \\ 0 & for \vert f \vert \geq {f}_{c} . . .\end{matrix}$$

The equalizer yielding ISI-free response for pulse p is given by:

$${EQ}_{p} ( f ) = \frac{{RC}_{β} ( f )}{{C}_{p} ( f ) MTF ( f )}$$

If we now apply a different pulse, i.e. a pulse for which the equalizer was not made ISI free, residual ISI will result. Suppose the equalizer was made ISI-free for pulse e, while pulse p is applied, then the output pulse response function can be written as:

$$\begin{matrix}y ( t ) = {ℱ}^{- 1} \{ {C}_{p} ( f ) MTF ( f ) {EQ}_{e} ( f ) \} \\ = {ℱ}^{- 1} \{ \frac{{RC}_{β} ( f )}{{C}_{e} ( f )} {C}_{p} ( f ) \}\end{matrix}$$

and this result suffers from ISI for p≠e.

FIG. 4 shows pulses after equalization. The pulses are plotted to get an impression of the type of non-linearity and ISI. For this purpose, a multilevel system was taken using M=8.

FIG. 4a shows pulses using an equalizer optimized for a minimum length pulse. The equalizer is optimized for p=1 using the above formulas. The pulse response y(t) for 8 different pulses is shown, the y-axis being the nominal read-out time 61. The signal values at a distance T are the residual ISI values at the read-out time of the neighboring cells: the next neighbor 62 and the second succeeding neighbor 63. The nominal maximum signal level 64 is indicated on the y-axis and corresponds to level=8. It can be seen that the pulse response 66 for level=1 has the nominal value of 1 at the y-axis due to the equalizer being determined for that pulse. The pulse response 65 for level=8 deviates substantially from the maximum level 64.

FIG. 4b shows pulses using an equalizer optimized for a medium length pulse. The equalizer is optimized for p=4.5 using the above formulas. The pulse response y(t) for 8 different pulses is shown as in FIG. 6a. It can be seen that the pulse response 68 for level=1 has the nominal value of more than 1 at the y-axis due to the equalizer not being determined for that pulse. The pulse response 67 for level=8 deviates from the maximum level 64, but less than in FIG. 6a.

FIG. 4c shows pulses using an equalizer optimized for a maximum length pulse. The equalizer is optimized for p=8 using the above formulas. The pulse response y(t) for 8 different pulses is shown as in FIG. 6a. It can be seen that the pulse response 70 for level=1 has the nominal value of substantially more than 1 at the y-axis due to the equalizer not being determined for that pulse. The pulse response 69 for level=8 now exactly is at the maximum level 64.

FIG. 5 shows inter symbol interference values dependent on the equalizer. The table gives ISI values for three equalizers, optimized for e=1, e=4.5 and e=8. It is noted that the values in the table of FIG. 7 correspond to the pulse responses drawn in FIG. 6. The table shows for each equalizer the signal values at the nominal read-out time (n=0), and the ISI values at the next three neighbors (n=1,2,3) for eight different signal levels (pulse lengths p=1 tot p=8).

It is noted that the model only describes non-linear effects due to equalization of length modulated pulses. There are also other non linear effects, e.g. the read out of optical discs is intrinsically non-linear. However, as the effect under investigation is quite severe, the current channel model by means of a linear MTF is a practical tool. Further, the model assumes that marks are only modulated in length, and not in amplitude or shape. Measurements confirm that length modulation is the main effect in the current high density media (e.g. using fast cooling fast growth phase change material).

From the above it is concluded that a combination of linearization and ISI compensation are required. Hence first a linear equalizer is optimized for a single length of the marks, as discussed with reference to FIG. 7. Secondly a non-linear equalizer is optimized taking into account the optimized linear equalizer based on the model, e.g. as shown in FIG. 5. Non-linearity as well as ISI appear not to be very dependent on density, though the effect tends to decrease slightly with density. The non-linear and ISI effects mainly are a property of the pulse length modulation system, and can be successfully compensated by the equalization as proposed.

For read signal equalization the proposed compensation span is at least nearest neighbor (3 taps), but may be one more neighbor (5-taps) may further improve system performance. If the ISI is not too severe, an approximation of the ISI is made from a single sample (in which further ISI is neglected), followed by subtraction of this approximated value from the neighboring signal samples. For a system having more severe ISI the neighboring samples may be also included for calculating ISI correction values. The correction values may be calculated or a lookup table may be included for providing table lookup or a non-linear function in a finite impulse response (FIR) equalizer. The idea is implemented in the non-linear equalizers shown in FIGS. 6 and 9.

FIG. 6 shows read signal equalization by a combination of a linear equalizer and a non-linear equalizer. A read signal is entered on input 80 to a linear equalizer 81. The linear equalizer is optimized for a predefined pulse as discussed above, and is shown in FIG. 7. A non linear equalizer 89 for reducing the inter symbol interference is coupled to the linear equalizer 81 and provides an output signal to a linearizer 88. The non-linear equalizer comprises a number of delay elements 82,83,84 having a delay D of one symbol for determining a previous and next signal at the previous and succeeding symbol readout time. The previous and next signal are coupled to ISI calculators 85,86 for calculating a correction value. The correction values are subtracted from the main signal in summing unit 87. The ISI calculator is based on the model of the channel as discussed above, and is shown in FIG. 10.

FIG. 7 shows a linear equalizer. The implementation of the equalizer is as a discrete-time digital filter using the finite impulse response (FIR) structure. A read signal is received on an input 32 to a series of delay elements 33. The input signal is coupled to a first input of a multiplier unit 34, which has a filter coefficient 35 called C₀ on a second input. The delayed versions of the input signal are coupled to respective multiplier units having corresponding coefficients (C₁, C₂, C₃, C₄). The results from the multiplying are coupled to a summing unit 36 to generate an output signal 37. The coefficients of the linear equalizer are chosen such that the output result is free of ISI for the particular selected value of mark length p. As explained above ISI-free operation for all p is impossible in pulse width modulated systems. For a given storage system the channel response is known, and the coefficients can be determined in advance. Alternatively, or as an additional calibration, the coefficients are determined adaptively by an adaptive equalizer method.

FIG. 8 shows a linear equalizer and adaptation of the coefficients. A linear equalizer unit 40 corresponds to the linear equalizer described above with reference to FIG. 7, wherein the coefficients 35 are adaptable based on the output of a least mean square unit 44, as indicated by arrow 45. The output 37 of the linear equalizer 40 is coupled to a symbol detector 41, which detects the symbols received. The output of the symbol detector 41 is coupled to a target response unit 42, which provides the desired response signal after equalization for the symbols detected. A summing unit 43 compares the desired response and the real signal on the output 37, which provides the input signal for the least mean square unit 44. The LMS equalizer aims at minimization of the mean square error between the output of the equalizer and a chosen target response of equalizer plus channel, when used to equalize a channel that suffers from ISI and noise (see for example the book; J. W. M. Bergmans: Digital baseband transmission and recording, Kluwer, Boston, 1996 ISBN 0-7923-9775-4). The target response is a full-response function (in discrete time: a delta impulse in case of bit synchronous implementation). However it is to be noted, that according to the invention, the adaptation is restricted to a particular pulse length. For example, when the linear equalizer is set for a pulse length of 8, only symbols of that length are selected for use in the algorithm. The update algorithm is arranged such that other pulse lengths do not contribute to the adaptation.

FIG. 9 shows an alternative circuit for read signal equalization. The linear equalizer 81, the ISI calculator 85, the summing unit 87 and the linearizer 88 correspond to FIG. 6. The non linear equalizer comprises a different number of delay elements, a first chain of delay elements 91,92,93 delays the correction values of a single ISI calculator 85. A second chain of delay elements 94,95 delays the input signal. The correction values are subtracted from the main signal in summing unit 87.

FIG. 10 shows correction values for an ISI calculator. A curve 101 shows the relation between input and output. A table 102 gives the numerical relation from input to output. The correction values are based on the values shown in FIG. 5 for an equalizer at p=4.5 and the next neighbor n=1.

FIG. 11 shows correction values for a linearizer. A curve 103 shows the relation between input and output. A table 104 gives the numerical relation from input to output. The correction values are based on the values shown in FIG. 5 for an equalizer at p=4.5 and the nominal signal n=0. It is to be noted that the linearizer may also be combined with a detector/discriminator which receives the output value of the read signal after equalization and converts the multilevel read signal in a digital value, e.g. a 3 bit value for each symbol.

It is noted that the equalizer described above is particularly suitable for use in multilevel system in optical recording. However the system is also suitable for other types of recording using different pulse shapes, wherein the equalizer can be optimized for one of the pulse shapes only and further pulses cause residual ISI. Also the system is suitable for read-only systems, because then no influence on the write channel is available and equalization can only be applied in the read channel.

In an embodiment the correction values established by the model as discussed above are augmented by read calibration. A record carrier may be provided with known test patterns, which can be read and analyzed for adapting parameters in the equalizer. Also other learning patterns on a disc or signals detected from data may be used to adapt the equalizer parameters to the actual record carrier. For example in the read signal predefined elements may be selectively used to calibrate the equalizers. Only read signals due to marks having the predefined length for which the linear equalizer is optimized are used to calibrate the linear equalizer.

It is noted that there is a relation between the selection of the equalizer and the residual ISI. When a specific selection of equalizer is predefined for the read channel, the optimization of a write strategy power pattern can be adapted to that equalizer. Hence the power patterns defined for the different marks are adapted to a presumed read channel and equalizer. From the table in FIG. 5 it appears that if the equalizer is optimized for the longest pulse length, the main non-linear ISI and nonlinearity is associated with the pulses of moderate length. A write strategy for pulses of moderate length usually allows more freedom for adaptation then the write strategy for the shortest or longest pulses. Hence preferably the equalizer is optimized for a longer, in particular the longest, mark. The power pattern for writing the longest mark can be optimized for maximum read signal, i.e. no additional requirements for reducing ISI are necessary at the write strategy because the read equalizer is optimized for such pulses.

Although the invention has been explained mainly by embodiments using the multilevel optical recording systems, the invention can be used for binary recording systems also, e.g. for retrieving the location of the zero crossings of the read signal. It is noted that in this document the word recordable includes re-writable and recordable once. Also for the information carrier an optical disc has been described, but other media, such as optical card or magnetic tape, may be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for scanning a track (11) on a record carrier (4) for reading information, the device comprising:
a head (22) for generating a read signal via a beam of radiation for scanning marks in the track, the marks having a number of different shapes for representing the information,
read means (30) for processing the read signal, the read means comprising a combination of a linear equalizer (81) and a non-linear equalizer (89) for equalizing the read signal,
the linear equalizer (81) being arranged for equalizing based on a mark having a single predefined shape, and
the non-linear equalizer (89) being arranged for reducing inter symbol interference in the read signal for marks having a different shape then said predefined shape, the inter symbol interference remaining in the read signal due to said linear equalizer being based on said single predefined shape.

2. Device as claimed in claim 1, wherein the read means (30) are for processing the read signal for generating a corresponding number of different levels of a processed read signal at a read-out time for said number of different shapes.

3. Device as claimed in claim 1, wherein said number of different shapes comprises longer and shorter shapes, and the linear equalizer (81) is arranged for equalizing based on a mark having a longer shape.

4. Device as claimed in claim 3, wherein the linear equalizer (81) is arranged for equalizing based on a mark having the longest shape of said different shapes.

5. Device as claimed in claim 1, wherein the linear equalizer (81) comprises a finite impulse response filter having delay elements coupled to multiplying elements, the multiplying elements containing multiplying coefficients that are based on said single predefined shape.

6. Device as claimed in claim 1, wherein the non-linear equalizer (89) comprises delay elements coupled to an inter symbol interference calculator (85,86), the inter symbol interference calculator being arranged to calculate the inter symbol interference based on a sequence of read signal values representing a sequence of marks.

7. Method of equalizing a read signal during reading information in a track on a record carrier, the method comprising
receiving a read signal generated by marks in the track, the marks having a number of different shapes for representing the information,
processing the read signal by a combination of linear equalization and a non-linear equalization for equalizing the read signal,
the linear equalization being arranged for equalizing based on a mark having a single predefined shape, and
the non-linear equalization being arranged for reducing inter symbol interference in the read signal for marks having a different shape then said predefined shape, the inter symbol interference remaining in the read signal due to said linear equalizer being based on said single predefined shape.
